(19) United States
(12) Patent Application Publication
(10) Pub. No.: US 2018/0071679 A1
(43) Pub. Date: Mar. 15, 2018

(54) Automotive Catalysts With Palladium Supported In An Alumina-Free Layer

(71) Applicant: BASF CORPORATION, FLORHAM PARK, NJ (US)

(72) Inventors: Andrey Karpov, Mannheim (DE); Michel Deeba, East Brunswick, NJ (US); Sven Titlbach, Heidelberg (DE); Andreas Sundermann, Bensheim (DE); Stephan Andreas Schunk, Heidelberg (DE)

(73) Assignee: BASF CORPORATION, FLORHAM PARK, NJ (US)

(21) Appl. No.: 15/554,532

(22) PCT Filed: Mar. 17, 2016
(86) PCT No.: PCT/US16/22853

§ 371 Date: Aug. 30, 2017

Related U.S. Application Data
(60) Provisional application No. 62/135,450, filed on Mar. 19, 2015.

(51) Int. Cl. B01D 53/94; B01J 37/02; B01J 21/06; B01J 23/10; B01J 23/44; F01N 3/20

(52) U.S. Cl. CPC B01D 53/945; B01J 23/002; B01J 21/06; B01J 23/10; B01J 23/44; F01N 3/20; B01D 2255/1023; B01D 2255/2042; B01D 2255/2061; B01D 2255/2063; B01D 2255/2065; B01D 2255/2068; B01D 2255/20715; B01D 2255/407; B01D 2255/908; B01D 2255/9207; B01J 37/0248

(57) ABSTRACT

Catalysts that improve carbon monoxide (CO), hydrocarbon (HC), Catalyst outlet temperature and speed traces of and nitrogen oxides (NOx) light-off performance are provided. A catalyst composite for combustion engines, as provided herein, comprises a carrier and a first layer comprising a catalytic material on the carrier, the catalytic material comprising a palladium component supported on both a ceria-praseodymia-based oxygen storage component and a ceria-zirconia-based oxygen storage component, wherein the first layer is essentially free of alumina. The catalytic material is effective to substantially simultaneously oxidize carbon monoxide and hydrocarbons and reduce nitrogen oxides.

### TECHNICAL FIELD OF THE INVENTION

This invention is directed to emission treatment systems comprising catalysts used to treat gaseous streams of combustion engines containing hydrocarbons, carbon monoxide, and oxides of nitrogen. More specifically, automotive catalysts are described herein which have a layer that is essentially free from alumina and that contains palladium supported on two different oxygen storage components: (1) a ceria-praseodymia-based composite and (2) a ceria-zirconia-based composite. Excellent three-way conversion (TWC) catalytic activity at low temperatures (≦350° C.) is achieved using such catalysts.

### BACKGROUND OF THE INVENTION

Three-way conversion (TWC) catalysts are used in engine exhaust streams to catalyze the oxidation of unburned hydrocarbons (HCs) and carbon monoxide (CO) and the reduction of nitrogen oxides (NOx) to nitrogen. The presence of an oxygen storage component (OSC) in a TWC catalyst allows oxygen to be stored during (fuel) lean conditions to promote reduction of NOx adsorbed on the catalyst, and to be released during (fuel) rich conditions to promote oxidation of HCs and CO adsorbed on the catalyst. TWC catalysts typically comprise one or more platinum group metals (PGM) (e.g., platinum, palladium, rhodium, and/or iridium) located upon one or more supports such as a high surface area, refractory oxide support, e.g., a high surface area alumina or a mixed metal oxide composite support that contains ceria. The ceria-containing mixed metal oxide composite provides oxygen storage capacity. The supported PGMs are carried on a suitable carrier or substrate such as a monolithic carrier comprising a refractory ceramic or metal honeycomb structure, or refractory particles such as spheres or short, extruded segments of a suitable refractory material.

Emission standards for unburned hydrocarbons, carbon monoxide and nitrogen oxide contaminants continue to become more stringent. For example, government regulations (such as LEV III in the US and Euro 6 & 7 in Europe) are targeting emissions during cold start and before the catalyst has fully warmed up. One strategy to address this is to ensure that PGMs are delivered by supports that do not interfere with and that enhance performance of the PGMs at lower temperatures. Also, operating temperatures of gasoline vehicles have been gradually decreasing over the past years, which means that high catalyst activity at low temperatures has become an important consideration in catalyst design.

With respect to low catalyst operating temperatures, Shigapov et al. in Thermally stable, high-surface-area, PrO_{y}—CeO₂-based mixed oxides for use in automotive-exhaust catalysts (Studies in Surface Science and Catalysis, 2000, vol. 130, p. 1373-1378) discuss high-surface-area praseodymia-ceria-based mixed oxides, which are reported to provide much more oxygen storage capacity than ceria-zirconia at low temperature ≦350° C. According to Shigapov et al., addition of zirconium, yttrium, or calcium to praseodymia-ceria increased the surface area and thermal stability but decreased the low-temperature oxygen storage capacity. Also shown in Shigapov et al. is that ceria-zirconia exhibits the best oxygen storage capacity at 500° C. relative to the various praseodymia-ceria-based mixed oxides disclosed therein.

U.S. Pat. No. 6,423,293 (Ford Global Technologies, Inc.) discloses an oxygen storage material for automotive catalysts and a process of using this material. The mixed oxide oxygen storage material consists essentially of praseodymium oxide loaded onto a high surface area cerium oxide or cerium-zirconium oxide, the molar ratio of praseodymium to cerium in the mixed oxide being 1:4 to 4:1.

U.S. Pat. No. 6,893,998 (Ford Global Technologies, LLC) states that it provides a cost-effective material which lowers the cold-start emissions from the exhaust of vehicles. The '998 patent discusses that the state of the art used palladium with a cerium-zirconium mixed oxide support, an aluminum oxide support, or a mixture thereof to give off oxygen at startup conditions (low temperature), in order to accelerate light-off of the catalyst. As a way to provide a cost-effective alternative to palladium on ceria-zirconia, the '998 patent specifically discloses an oxide mixture having praseodymium and cerium, doping about 0-10% weight zirconium and about 0-10% weight yttrium into the oxide mixture, adding about 0-2% by weight of a metal including palladium, platinum, or rhodium to the oxide mixture, mixing gamma aluminum into the oxide mixture for washcoating, and washcoating the oxide mixture onto a monolithic substrate.

There is a continuing need in the art to provide catalytic articles that provide excellent catalytic activity and/or light-off performance and/or efficient use of components to achieve regulated emissions, especially at decreasing operating temperatures.

### SUMMARY OF THE INVENTION

Provided are catalyst composites for combustion engines and method of making and using the same.

In a first aspect, a catalyst composite for combustion engines is provided, which comprises: a carrier and a first layer comprising a catalytic material on the carrier, the catalytic material comprising a palladium component supported on both a ceria-praseodymia-based oxygen storage component and on a ceria-zirconia-based oxygen storage component; wherein the first layer is essentially free of alumina. It is understood that the ceria-praseodymia-based oxygen storage component and the ceria-zirconia-based oxygen storage components are different materials.

The catalytic material may be effective to substantially simultaneously oxidize carbon monoxide and hydrocarbons and reduce nitrogen oxides.

The ceria-praseodymia-based oxygen storage component may comprise, by weight on an oxide basis: about 30 to about 60% Ce; about 10 to about 50% Pr; 0 to about 30% rare earth elements selected from the group consisting of La, Y, and Nd; and less than or equal to about 10% Zr.

The ceria-zirconia-based oxygen storage component may comprise, by weight on an oxide basis: about 10 to about 70% Ce; about 15 to about 90% Zr; and 0 to about 25% rare earth elements selected from the group consisting of La, Y, Pr, and Nd.

The first layer may further comprise a non-alumina binder. The non-alumina binder may comprise submicron particles of a zirconium component, a titanium component, or a ceria component.

A weight ratio of the ceria-praseodymia-based oxygen storage component to the ceria-zirconia-based oxygen storage component may be up to about 1.5:1 or in the range of about 0.15:1 to about 1.5:1 or about 0.25:1 to about 1.5:1. One particular weight ratio range of the ceria-praseodymia-based oxygen storage component to the ceria-zirconia-based oxygen storage component in certain embodiments is about 0.4:1 to about 0.7:1.

In one or more embodiments, about 0.1 to about 50 wt. % of the palladium component may be supported on the ceria-praseodymia-based oxygen storage component and about 50 to about 99.9 wt. % of the palladium component may be supported on the ceria-zirconia-based oxygen storage component. A loading of the ceria-praseodymia-based oxygen storage component and the ceria-zirconia-based oxygen storage component may be in the range of about 0.5 to about 3.5 g/in³.

The catalytic material may further comprise a stabilizer material selected from the group consisting of barium, calcium, magnesium, strontium, and mixtures thereof.

The composite may further comprise a second layer on the first layer, the second layer comprising a PGM component supported on a high surface area refractory metal oxide, an oxygen storage component, or combinations thereof. The PGM component of the second layer may, in certain embodiments, be supported on a high surface area refractory metal oxide support that comprises a compound that is activated, stabilized, or both, selected from the group consisting of alumina, alumina-zirconia, lanthana-alumina, lanthana-zirconia-alumina, baria-alumina, baria-lanthana-alumina, baria-lanthana-neodymia-alumina, and alumina-ceria. In some embodiments, the PGM component of the second layer may be supported on an oxygen storage component that comprises a ceria-zirconia composite. The PGM component of the second layer may comprise a palladium component, a rhodium component, or both.

The composite may further comprise an undercoat on the carrier, positioned below the first layer, that is essentially free of any platinum group metals.

Another aspect provides a system for treatment of an internal combustion engine exhaust stream including hydrocarbons, carbon monoxide, and nitrogen oxides, the emission treatment system comprising: an exhaust conduit in fluid communication with the internal combustion engine via an exhaust manifold; and any catalyst composite disclosed herein.

A further aspect provides a method for treating exhaust gases comprising contacting a gaseous stream comprising hydrocarbons, carbon monoxide, and nitrogen oxides with any catalyst composite disclosed herein.

In an additional aspect, the disclosure provides a method of making a catalyst composite comprising: obtaining a carrier; and coating the carrier with a first washcoat comprising catalytic material, wherein the first washcoat is essentially free of alumina and comprises a palladium component supported on both a ceria-praseodymia-based oxygen storage component and a ceria-zirconia-based oxygen storage component to give a coated carrier; and drying and calcining the coated carrier to form a first layer on the catalyst composite. The method may further comprise: coating a second washcoat on the first layer, wherein the second washcoat comprises a platinum group metal (PGM) component supported on a high surface area refractory metal oxide or on an oxygen storage component; and drying and calcining the coated carrier to form a second layer on the catalyst composite. The method may further comprise adding a non-alumina binder.

### BRIEF DESCRIPTION OF THE DRAWINGS

The disclosure may be more completely understood in consideration of the following detailed description of various embodiments of the disclosure in connection with the accompanying drawings, in which:

FIG. 1 provides a graph of catalyst outlet temperature and speed traces of gasoline system simulator (GSS) test versus time (FTP-72 testing protocol);

FIG. 2 provides a graph of showing a comparison of non-Methane hydrocarbon emission data of catalysts prepared according to Example 1 and Comparative Example 3 after aging at 950° C. (FTP-72 testing protocol);

FIG. 3 provides a graph showing a comparison of NO emission data of catalysts prepared according to Example 1 and Comparative Example 3 after aging at 950° C. (FTP-72 testing protocol);

FIG. 4 provides a graph showing a comparison of CO emission data of catalysts prepared according to Example 1 and Comparative Example 3 after aging at 950° C. (FTP-72 testing protocol);

FIG. 5 provides a graph showing a comparison of non-Methane hydrocarbon emission of catalysts prepared according to Comparative Example 5 and Comparative Example 6 after aging at 950° C. (FTP-72 testing protocol);

FIG. 6 provides a graph showing a comparison of NO emission data of catalysts prepared according to Comparative Example 5 and Comparative Example 6 after aging at 950° C. (FTP-72 testing protocol); and

FIG. 7 provides a graph showing a comparison of CO emission data of catalysts prepared according to Comparative Example 5 and Comparative Example 6 after aging at 950° C. (FTP-72 testing protocol).

### DETAILED DESCRIPTION OF THE INVENTION

Catalysts that improve carbon monoxide (CO), hydrocarbon (HC), and nitrogen oxides (NOx) light-off performance are provided. Ceria-praseodymia (Ce—Pr) is an effective oxygen storage component for supporting palladium, providing excellent light-off at low catalyst operating temperatures (T≦350° C.). Ceria-zirconia (Ce—Zr) is a traditional oxygen storage component that, when used for supporting palladium, historically provides excellent activity at high catalyst operating temperatures (T≧350° C.). It has been surprisingly found that using two different oxygen storage components (OSCs) for palladium—one OSC being Ce—Pr-based and the other OSC being Ce—Zr-based, provides even better light-off at low catalyst operating temperatures (T≦350° C.) in comparison to palladium supported on only a Ce—Pr-based OSC or on only a Ce—Zr-based OSC.

With respect to Ce—Pr-based OSCs, it has been observed that any HC or NOx light off improvement suffers when alumina is present along with the Ce—Pr in the Pd layer. Thus, the catalysts herein essentially exclude alumina in the layer containing the Pd supported on two different OSCs. That is, such a layer does not use any source of alumina as a support material or as a binder. Such a layer is considered “essentially alumina-free” since alumina is not intentionally provided in the layer. It is recognized, however, that the material may migrate or diffuse to the layer in minor amounts considered to be insubstantial (that is <1% by weight of the layer, or less than 0.9%, 0.75, or even 0.5%). As used herein, therefore, a layer that is “essentially free of alumina” is a layer containing no more than about 1% by weight of aluminum oxide, and encompasses layers containing even lesser amounts of aluminum oxide.

Ce—Pr-based OSCs generally have the following compositions, with weight % reported on an oxide basis: about 30 to about 60 wt. % Ce, about 10 to about 50 wt. % (or about 20 to about 50 wt. %, or about 30 to about 45 wt. %) Pr, 0 to about 30 wt. % (or even about 10 to about 20 wt. %) rare earth elements (La, Y, Nd), and less than or equal to about 10 wt. % Zr. For Ce—Pr-based OSCs, in one or more embodiments, Ce and Pr may together account for at least about 60 wt. % of the OSC.

Ce—Zr-based OSCs generally have the following compositions, with weight % reported on an oxide basis: about 10 to about 70 wt. % Ce, about 15 to about 90 wt. % Zr, and 0 to about 25 wt. % rare earth elements (La, Y, Pr, Nd). For Ce—Zr-based OSCs, in one or more embodiments, Ce and Zr may together account for at least about 60 wt. % of the OSC.

Catalytic materials described herein use two different OSCs for supporting palladium. The first OSC is Ce—Pr-based and the second OSC is Ce—Zr-based. The catalytic material may optionally contain binder materials that are not alumina. The rest of the catalytic material is designed to deliver whatever further catalytic activity is desired to meet automotive design needs and regulatory requirements. That is, other platinum group metals on suitable supports may be present along with stabilizing materials and the like. Typically, both the palladium on the Ce—Pr-based OSC and the palladium on the Ce—Zr-based OSC are in the same layer. It is also contemplated herein, however, that the palladium on the Ce—Zr-based OSC could be zoned upstream from the palladium on the Ce—Pr-based OSC.

Exemplary non-alumina binders include metal-based binders and organic binders. Metal-based binders include, but are not limited to, zirconium, titanium, and/or cerium. Such binders are typically submicron particles that may be delivered colloidally or by a precursor salt component. Precursor salt components may be acetates, nitrates, and/or hydroxides. Exemplary precursor salt components of zirconium are: acetate, zirconyl acetate, zirconyl nitrate, and zirconium hydroxide. Organic binders include, but are not limited to: poly(vinylalcohol), poly(vinylpyrrolidone), poly(ethyleneimine), poly(acrylic acid), and carbohydrates.

The following definitions are used herein.

A platinum group metal (PGM) component refers to any compound that includes a PGM. For example, the PGM may be in metallic form—zero valance, or the PGM may be in an oxide form. PGM may be also in a mixed state. For example, the PGM surface may be in an oxide form, whereas the PGM core may be in metallic form. Reference to PGM component allows for the presence of the PGM in any valance state. For example, palladium may be present in Pd⁰ and/or Pd²⁺, or Pd⁴⁺. Also, for example, rhodium may be present in Rh⁰, Rh¹⁺, and/or Rh³⁺.

“BET surface area” has its usual meaning of referring to the Brunauer-Emmett-Teller method for determining surface area by N₂-adsorption measurements. Unless otherwise stated, “surface area” refers to BET surface area.

“Support” in a catalytic material or catalyst washcoat refers to a material that receives precious metals, stabilizers, promoters, binders, and the like through precipitation, association, dispersion, impregnation, or other suitable methods. Examples of supports include, but are not limited to, refractory metal oxides, including high surface area refractory metal oxides, and composites containing oxygen storage components.

“Refractory metal oxide supports” include bulk alumina, ceria, zirconia, titania, silica, magnesia, neodymia, mixed oxides (for example MgAl₂O₄, BaAl₁₂O₁₉, LaAlO₃) or doped oxides (for example Ba-doped alumina, Ce-doped alumina, La-doped alumina), doped mixed metal oxides (for example Y-, La-, Pr- or Nd-doped CeZr-oxides), and other materials are known for such use. Such materials are considered as providing durability to the resulting catalyst. Refractory metal oxide supports are generally porous.

“High surface area refractory metal oxide supports” refer specifically to support particles having BET surface areas of higher than 30 square meters per gram (“m²/g”) and pores larger than 20 Å and a wide pore distribution. High surface area refractory metal oxide supports, e.g., alumina support materials, also referred to as “gamma alumina” or “activated alumina,” typically exhibit a BET surface area in excess of 60 square meters per gram (“m²/g”), often up to about 200 m²/g or higher. Such activated alumina is usually a mixture of the gamma and delta phases of alumina, but may also contain substantial amounts of eta, kappa and theta alumina phases.

“Rare earth metal oxides” refer to one or more oxides of scandium, yttrium, and the lanthanum series defined in the Periodic Table of Elements. Rare earth metal oxides are both exemplary oxygen storage components and promoter materials. Examples of suitable oxygen storage components include ceria, praseodymia, or combinations thereof. Delivery of ceria can be achieved by the use of, for example, ceria, a mixed oxide of cerium and zirconium, and/or a mixed oxide of cerium, zirconium, and neodymium. Suitable promoters include one or more non-reducible oxides of one or more rare earth metals selected from the group consisting of lanthanum, praseodymium, yttrium, zirconium and mixtures thereof.

“Alkaline earth metal oxides” refer to Group II metal oxides, which are exemplary stabilizer materials. Suitable stabilizers include one or more non-reducible metal oxides wherein the metal is selected from the group consisting of barium, calcium, magnesium, strontium, and mixtures thereof. Preferably, the stabilizer comprises one or more oxides of barium and/or strontium.

“Washcoat” is a thin, adherent coating of a catalytic or other material applied to a refractory substrate, such as a honeycomb flow through monolith substrate or a filter substrate, which is sufficiently porous to permit the passage there through of the gas stream being treated. A “washcoat layer,” therefore, is defined as a coating that is comprised of support particles. A “catalyzed washcoat layer” is a coating comprised of support particles impregnated with catalytic components.

### Catalyst Composites

Once the catalytic materials are prepared, a catalyst composite may be prepared from one or more layers of catalytic material on a carrier. A dispersion comprising a catalytic material is used to form a slurry for a washcoat. To the slurry may be added any desired additional ingredients, such as other platinum group metals, other supports, other stabilizers and promoters, and one or more oxygen storage components.

In one or more embodiments, the slurry is acidic, having a pH of about 2 to less than about 7. The pH of the slurry may be lowered by the addition of an adequate amount of an inorganic or an organic acid to the slurry. Combinations of both an inorganic and organic acid can be used when compatibility of acid and raw materials is considered. Inorganic acids include, but are not limited to, nitric acid. Organic acids include, but are not limited to, acetic, propionic, oxalic, malonic, succinic, glutamic, adipic, maleic, fumaric, phthalic, tartaric, citric acid and the like. Thereafter, if desired, water-soluble or water-dispersible compounds of oxygen storage components, e.g., cerium-zirconium composites, a stabilizer, e.g., barium acetate, and a promoter, e.g., lanthanum nitrate, may be added to the slurry. The slurry may thereafter be comminuted to result in substantially all of the solids having particle sizes of less than about 20 microns, e.g., about 0.1 to about 15 microns average diameter. The comminution may be accomplished in a ball mill or other similar equipment, and the solids content of the slurry may be, e.g., about 10 to about 50 wt. %, more particularly about 10 to about 40 wt. %.

The carrier may then be dipped one or more times in such slurry or the slurry may be coated on the carrier such that there will be deposited on the carrier the desired loading of the washcoat/metal oxide composite, e.g., about 0.5 to about 3.0 g/in³. Thereafter the coated carrier is calcined by heating, e.g., at 500-600° C. for about 1 to about 3 hours.

Typically, when platinum group metal is desired, a metal component is utilized in the form of a compound or complex to achieve dispersion of the component on a refractory metal oxide support, e.g., activated alumina or a ceria-zirconia composite or a ceria-praseodymia composite. For the purposes herein, the term “metal component” means any compound, complex, or the like which, upon calcination or use thereof, decomposes or otherwise converts to a catalytically active form, usually the metal or the metal oxide. Water-soluble compounds or water-dispersible compounds or complexes of the metal component may be used as long as the liquid medium used to impregnate or deposit the metal component onto the refractory metal oxide support particles does not adversely react with the metal or its compound or its complex or other components which may be present in the catalyst composition and is capable of being removed from the metal component by volatilization or decomposition upon heating and/or application of a vacuum. In some cases, the completion of removal of the liquid may not take place until the catalyst is placed into use and subjected to the high temperatures encountered during operation. Generally, both from the point of view of economics and environmental aspects, aqueous solutions of soluble compounds or complexes of the precious metals are utilized. During the calcination step, or at least during the initial phase of use of the composite, such compounds are converted into a catalytically active form of the metal or a compound thereof.

Additional layers may be prepared and deposited upon previous layers in the same manner as described above for deposition any layer upon the carrier. Moreover, zoned designs using different slurries for a front zone and a back zone are contemplated. Furthermore, other zoned and layered combinations may also be desirable.

### Carrier

In one or more embodiments, catalytic material is disposed on a carrier.

The carrier may be any of those materials typically used for preparing catalyst composites, and will preferably comprise a ceramic or metal honeycomb structure. Any suitable carrier may be employed, such as a monolithic substrate of the type having fine, parallel gas flow passages extending therethrough from an inlet or an outlet face of the substrate, such that passages are open to fluid flow therethrough (referred to as honeycomb flow through substrates). The passages, which are essentially straight paths from their fluid inlet to their fluid outlet, are defined by walls on which the catalytic material is coated as a washcoat so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain from about 60 to about 900 or more gas inlet openings (i.e., cells) per square inch of cross section.

The carrier can also be a wall-flow filter substrate, where the channels are alternately blocked, allowing a gaseous stream entering the channels from one direction (inlet direction), to flow through the channel walls and exit from the channels from the other direction (outlet direction). A dual oxidation catalyst composition can be coated on the wall-flow filter—on inlet sides, or outlets sides, or both. If such a carrier is utilized, the resulting system will be able to remove particulate matters along with gaseous pollutants. The wall-flow filter carrier can be made from materials commonly known in the art, such as cordierite or silicon carbide.

The carrier may be made of any suitable refractory material, e.g., cordierite, cordierite-alumina, silicon nitride, zircon mullite, spodumene, alumina-silica magnesia, zircon silicate, sillimanite, a magnesium silicate, zircon, petalite, alumina, an aluminosilicate and the like.

The carriers useful for the catalysts of the present invention may also be metallic in nature and be composed of one or more metals or metal alloys. The metallic carriers may be employed in various shapes such as corrugated sheet or monolithic form. Preferred metallic supports include the heat resistant metals and metal alloys such as titanium and stainless steel as well as other alloys in which iron is a substantial or major component. Such alloys may contain one or more of nickel, chromium and/or aluminum, and the total amount of these metals may advantageously comprise at least about 15 wt. % of the alloy, e.g., about 10 to about 25 wt. % of chromium, about 3 to about 8 wt. % of aluminum and up to about 20 wt. % of nickel. The alloys may also contain small or trace amounts of one or more other metals such as manganese, copper, vanadium, titanium and the like. The surface of the metal carriers may be oxidized at high temperatures, e.g., 1000° C. and higher, to improve the resistance to corrosion of the alloys by forming an oxide layer on the surfaces of the carriers. Such high temperature-induced oxidation may enhance the adherence of the refractory metal oxide support and catalytically promoting metal components to the carrier.

In alternative embodiments, one or more catalyst compositions may be deposited on an open cell foam substrate. Such substrates are well known in the art, and are typically formed of refractory ceramic or metallic materials.

Before describing several exemplary embodiments of the invention, it is to be understood that the invention is not limited to the details of construction or process steps set forth in the following description. The invention is capable of other embodiments and of being practiced in various ways. In the following, preferred designs are provided, including such combinations as recited used alone or in unlimited combinations, the uses for which include catalysts, systems, and methods of other aspects of the present invention.

### EMBODIMENTS

Various embodiments are listed below. It will be understood that the embodiments listed below may be combined with all aspects and other embodiments in accordance with the scope of the invention.

### Embodiment 1

A catalyst composite for combustion engines comprising: a catalytic material on a carrier, the catalytic material comprising at least a first layer disposed above the carrier that comprises: a palladium component supported on both a ceria-praseodymia-based oxygen storage component and on a ceria-zirconia-based oxygen storage component; wherein the first layer is essentially free of alumina.

### Embodiment 2

The composite of embodiment 1, wherein the catalytic material is effective to substantially simultaneously oxidize carbon monoxide and hydrocarbons and reduce nitrogen oxides.

### Embodiment 3

The composite of any of embodiments 1-2, wherein the ceria-praseodymia-based oxygen storage component comprises, by weight on an oxide basis: about 30 to about 60% Ce; about 10 to about 50% Pr; 0 to about 30% rare earth elements selected from the group consisting of La, Y, and Nd; and less than or equal to about 10% Zr.

### Embodiment 4

The composite of any of embodiments 1-3, wherein the ceria-zirconia-based oxygen storage component comprises, by weight on an oxide basis: about 10 to about 70% Ce; about 15 to about 90% Zr; and 0 to about 25% rare earth elements selected from the group consisting of La, Y, Pr, and Nd.

### Embodiment 5

The composite of any of embodiments 1-4, wherein the first layer further comprises a non-alumina binder.

### Embodiment 6

The composite of embodiment 5 wherein the non-alumina binder comprises submicron particles of a zirconium component, a titanium component, or a ceria component.

### Embodiment 7

The composite of any of embodiments 1-6, wherein a weight ratio of the ceria-praseodymia-based oxygen storage component to the ceria-zirconia-based oxygen storage component is in the range of 0.25:1 to 1.5:1.

### Embodiment 8

The composite of any of embodiments 1-7, wherein about 0.1 to about 50 wt. % of the palladium component is supported on the ceria-praseodymia-based oxygen storage component and about 50 to about 99.9 wt. % of the palladium component is supported on the ceria-zirconia-based oxygen storage component

### Embodiment 9

The composite of any of embodiments 1-8, wherein a loading of the ceria-praseodymia-based oxygen storage component and the ceria-zirconia-based oxygen storage component is in the range of about 0.5 to about 3.5 g/in³.

### Embodiment 10

The composite of any of embodiments 1-9, wherein the catalytic material further comprises a stabilizer material selected from the group consisting of barium, calcium, magnesium, strontium, and mixtures thereof.

### Embodiment 11

The composite of any of embodiments 1-11 further comprising a second layer on the first layer, the second layer comprising a PGM component supported on a high surface area refractory metal oxide, an oxygen storage component, or combinations thereof.

### Embodiment 12

The composite of embodiment 11, wherein the PGM component is supported on the high surface area refractory metal oxide and wherein the high surface refractory metal oxide comprises a compound that is activated, stabilized, or both selected from the group consisting of alumina, alumina-zirconia, lanthana-alumina, lanthana-zirconia-alumina, baria-alumina, baria-lanthana-alumina, baria-lanthana-neodymia-alumina, and alumina-ceria.

### Embodiment 13

The composite of embodiment 11, wherein the PGM component is supported on the oxygen storage component and wherein the oxygen storage component comprises a ceria-zirconia composite.

### Embodiment 14

The composite of embodiment 11, wherein the PGM component comprises a palladium component, a rhodium component, or both.

### Embodiment 15

The composite of any of embodiments 1-14 further comprising an undercoat that is on the carrier and below the first layer and that is essentially free of any platinum group metals.

### Embodiment 16

A system for treatment of an internal combustion engine exhaust stream including hydrocarbons, carbon monoxide, and nitrogen oxides, the emission treatment system comprising: an exhaust conduit in fluid communication with the internal combustion engine via an exhaust manifold; and the catalyst composite according to any of embodiments 1-15.

### Embodiment 17

A method for treating exhaust gases comprising contacting a gaseous stream comprising hydrocarbons, carbon monoxide, and nitrogen oxides with the catalyst composite according to any of embodiments 1-15.

### Embodiment 18

A method of making a catalyst composite comprising: obtaining a carrier; and coating the carrier with at least a first washcoat of catalytic material, wherein: the first washcoat is essentially free of alumina and comprises a palladium component supported on both a ceria-praseodymia-based oxygen storage component and a ceria-zirconia-based oxygen storage component; and drying and calcining the coated carrier to form a first layer on the catalyst composite.

### Embodiment 19

The method of embodiment 18, further comprising: coating a second washcoat on the first layer, wherein the second washcoat comprises a PGM component supported on a high surface area refractory metal oxide or on an oxygen storage component; and drying and calcining the coated carrier to form a second layer on the catalyst composite.

### Embodiment 20

The method of either of embodiments 18 or 19, further comprising adding a non-alumina binder to the first washcoat.

### EXAMPLES

The following non-limiting examples shall serve to illustrate the various embodiments of the present invention.

In each of the examples, a flow-through monolith having the following characteristics was used: a volume of 20.4 in³ (0.33 L), a cell density of 600 cells per square inch, and a wall thickness of approximately 100 μm.

### Example 1

Catalytic material comprising a palladium component supported on both a ceria-praseodymia-based oxygen storage component and a ceria-zirconia-based oxygen storage component in the absence of any alumina components was formed.

The washcoat was prepared as follows to deliver the recited amounts on a dry gain basis. 1.0 g/in³ of a ceria-praseodymia-based oxygen storage component I (cerium oxide: 45 wt. %, praseodymium oxide: 55 wt. %) was impregnated by incipient wetness with a palladium nitrate solution to support 30 wt. % of the palladium for the entire washcoat. The impregnated powder was calcined in air at 550° C. for 2 hours. 1.7 g/in³ of a ceria-zirconia-based oxygen storage component I (cerium oxide: 40 wt. %, zirconium oxide: 50 wt. %, lanthanum oxide: 5 wt. %; yttrium oxide: 5 wt. %) was impregnated by incipient wetness with a palladium nitrate solution to support 70 wt. % of the palladium for the entire washcoat. The impregnated powder was calcined in air at 550° C. for 2 hours. Barium sulfate corresponding to 0.15 g/in³ BaO and zirconia acetate corresponding to 0.05 g/in³ ZrO₂ were dispersed in water and acetic acid at a pH in the range from 4.0 to 5.0. Into this slurry, a mixture of the calcined impregnated powders of Pd on the ceria-praseodymia-based oxygen storage component and Pd on the ceria-zirconia-based oxygen storage component were dispersed, and the slurry was milled to a particle size of D₉₀ less than 18 micrometers. The final slurry was coated onto a monolith, dried at 110° C. in air and calcined at 550° C. in air. The palladium loading was 55 g/ft³ Pd.

### Example 2

Catalytic material comprising a palladium component supported on both a ceria-praseodymia-based oxygen storage component and a ceria-zirconia-based oxygen storage component in the absence of any alumina components was formed.

The washcoat was prepared as follows to deliver the recited amounts on a dry gain basis. 1.0 g/in³ of a ceria-praseodymia-based oxygen storage component II (cerium oxide: 50 wt. %, praseodymium oxide: 40 wt. %, lanthanum oxide 10 wt. %) was impregnated by incipient wetness with a palladium nitrate solution to support 30 wt. % of the palladium for the entire washcoat. The impregnated powder was calcined in air at 550° C. for 2 hours. 1.7 g/in³ of a ceria-zirconia-based oxygen storage component I (cerium oxide: 40 wt. %, zirconium oxide: 50 wt. %, lanthanum oxide: 5 wt. %; yttrium oxide: 5 wt. %) was impregnated by incipient wetness with a palladium nitrate solution to support 70 wt. % of the palladium for the entire washcoat. The impregnated powder was calcined in air at 550° C. for 2 hours. Barium sulfate corresponding to 0.15 g/in³ BaO and zirconia acetate corresponding to 0.05 g/in³ ZrO₂ were dispersed in water and acetic acid at a pH in the range from 4.0 to 5.0. Into this slurry, a mixture of the calcined impregnated powders of Pd on the ceria-praseodymia-based oxygen storage component and Pd on the ceria-zirconia-based oxygen storage component were dispersed, and the slurry was milled to a particle size of D₉₀ less than 18 micrometers. The final slurry was coated onto a monolith, dried at 110° C. in air and calcined at 550° C. in air. The palladium loading was 55 g/ft³ Pd.

### Example 3 (Comparative)

Catalytic material comprising a palladium component supported only on a ceria-zirconia-based oxygen storage component in the absence of any alumina components was formed.

The washcoat was prepared as follows to deliver the recited amounts on a dry gain basis. 2.7 g/in³ of a ceria-zirconia-based oxygen storage component I (cerium oxide: 40 wt. %, zirconium oxide: 50 wt. %, lanthanum oxide: 5 wt. %; yttrium oxide: 5 wt. %) was impregnated by incipient wetness with a palladium nitrate solution to support 100 wt. % of the palladium for the entire washcoat. The impregnated powder was calcined in air at 550° C. for 2 hours. Barium sulfate corresponding to 0.15 g/in³ BaO and zirconia acetate corresponding to 0.05 g/in³ ZrO₂ were dispersed in water and acetic acid at pH in the range from 4.0 to 5.0. Into this slurry the calcined impregnated powder of Pd on the ceria-zirconia-based oxygen storage component was dispersed, and the slurry was milled to a particle size of D₉₀ less than 18 micrometers. The final slurry was coated onto a monolith, dried at 110° C. in air and calcined at 550° C. in air. The palladium loading was 55 g/ft³ Pd.

### Example 4 (Comparative)

Catalytic material comprising a palladium component supported only on a ceria-praseodymia-based oxygen storage component in the absence of any alumina components was formed.

The washcoat was prepared as follows to deliver the recited amounts on a dry gain basis. 2.7 g/in³ of a ceria-praseodymia-based oxygen storage component I (cerium oxide: 45 wt. %, praseodymium oxide: 55 wt. %) was impregnated by incipient wetness with a palladium nitrate solution to support 100 wt. % of the palladium for the entire washcoat. The impregnated powder was calcined in air at 550° C. for 2 hours. Barium sulfate corresponding to 0.15 g/in³ BaO and zirconia acetate corresponding to 0.05 g/in³ ZrO₂ were dispersed in water and acetic acid at a pH in the range from 4.0 to 5.0. Into this slurry the calcined impregnated powder of Pd on the ceria-praseodymia-based oxygen storage component was dispersed, and the slurry was milled to a particle size of D₉₀ less than 18 micrometers. The final slurry was coated onto a monolith, dried and 110° C. in air and calcined at 550° C. in air. The palladium loading was 55 g/ft³ Pd.

Catalyst compositions (Win) of Examples 1-4 are summarized in Table 1.

TABLE 1
Catalyst compositions (g/in³) of Examples 1-4

| | | | Example 3 | Example 4 |
|---|---|---|---|---|
| | | | (COMPAR- | (COMPAR- |
| | Example 1 | Example 2 | ATIVE) | ATIVE) |
| CePr-based oxide I | 1.0 | | | 2.7 |
| La-doped CePr- | | 1.0 | | |
| based oxide II | | | | |
| CeZr-based oxide I | 1.7 | 1.7 | 2.7 | |
| BaO as sulphate | 0.15 | 0.15 | 0.15 | 0.15 |
| ZrO₂ as acetate | 0.05 | 0.05 | 0.05 | 0.05 |
| Pd as nitrate | 0.0318 | 0.0318 | 0.0318 | 0.0318 |
| Total coat | 2.932 | 2.932 | 2.932 | 2.932 |

### Example 5 (Comparative)

Catalytic material comprising a palladium component supported on both a ceria-praseodymia-based oxygen storage component and a ceria-zirconia-based oxygen storage component in the presence of a palladium component supported on an alumina component was formed.

The washcoat was prepared as follows to deliver the recited amounts on a dry gain basis. 0.4 g/in³ of a ceria-praseodymia-based oxygen storage component I (cerium oxide: 45 wt. %, praseodymium oxide: 55 wt. %) was impregnated by incipient wetness with a palladium nitrate solution to support 10 wt. % of the palladium for the entire washcoat. The impregnated powder was calcined in air at 550° C. for 2 hours. 1.3 g/in³ of a ceria-zirconia-based oxygen storage component II (cerium oxide: 45 wt. %, zirconium oxide: 45 wt. %, lanthanum oxide: 8 wt. %; praseodymium oxide: 2 wt. %) was impregnated by incipient wetness with a palladium nitrate solution to support 60 wt. % of the palladium for the entire washcoat. The impregnated powder was calcined in air at 550° C. for 2 hours. 1.0 g/in³ of a La-doped alumina component (aluminum oxide: 96 wt. %, lanthanum oxide: 4 wt. %) was impregnated by incipient wetness with a palladium nitrate solution to support 30 wt. % of the palladium for the entire washcoat. The impregnated powder was calcined in air at 550° C. for 2 hours. The calcined impregnated Pd supported on the La—Al₂O₃ component was dispersed in water and acetic acid at a pH in the range from 4.0 to 5.0, and the slurry was milled to a particle size of D₉₀ less than 25 micrometers. Into this slurry, barium sulfate corresponding to 0.15 g/in³ BaO and zirconia acetate corresponding to 0.05 g/in³ ZrO₂ were dispersed. Into this slurry, a mixture of the calcined impregnated powders of Pd on the ceria-praseodymia-based oxygen storage component and Pd on the ceria-zirconia-based oxygen storage component were dispersed, and the slurry was milled to a particle size of D₉₀ less than 18 micrometers. The final slurry was coated onto a monolith, dried at 110° C. in air and calcined at 550° C. in air. The palladium loading was 55 g/ft³ Pd.

### Example 6 (Comparative)

Catalytic material comprising a palladium component supported only on a ceria-zirconia-based oxygen storage component in the presence of a palladium component supported on an alumina component was formed.

The washcoat was prepared as follows to deliver the recited amounts on a dry gain basis. 1.7 g/in³ of a ceria-zirconia-based oxygen storage component II (cerium oxide: 45 wt. %, zirconium oxide: 45 wt. %, lanthanum oxide: 8 wt. %; praseodymium oxide: 2 wt. %) was impregnated by incipient wetness with a palladium nitrate solution to support 70 wt. % of the palladium for the entire washcoat. The impregnated powder was calcined in air at 550° C. for 2 hours. 1.0 g/in³ of a La-doped alumina component (aluminum oxide: 96 wt. %, lanthanum oxide: 4 wt. %) was impregnated by incipient wetness with a palladium nitrate solution to support 30 wt. % of the palladium for the entire washcoat. The impregnated powder was calcined in air at 550° C. for 2 hours. The calcined impregnated Pd supported on the La—Al₂O₃ component was dispersed in water and acetic acid at a pH in the range from 4.0 to 5.0, the slurry was milled to a particle size of D₉₀ less than 25 micrometers. Into this slurry, barium sulfate corresponding to 0.15 g/in³ BaO and zirconia acetate corresponding to 0.05 g/in³ ZrO₂ were dispersed. Into this slurry, the calcined impregnated powder of Pd on the ceria-zirconia-based oxygen storage component was dispersed, and the slurry was milled to a particle size of D₉₀ less than 18 micrometers. The final slurry was coated onto a monolith, dried at 110° C. in air and calcined at 550° C. in air. The palladium loading was 55 g/ft³ Pd.

Catalyst compositions (g/in³) of Examples 5-6 are summarized in Table 2.

TABLE 2
Catalyst compositions (g/in³) of Examples 5-6

| | Example 5 | Example 6 |
|---|---|---|
| | (COMPARATIVE) | (COMPARATIVE) |
| CePr-based oxide I | 0.4 | |
| CeZr-based oxide II | 1.3 | 1.7 |
| La—Al₂O₃ | 1.0 | 1.0 |
| BaO as sulphate | 0.15 | 0.15 |
| ZrO₂ as acetate | 0.05 | 0.05 |
| Pd as nitrate | 0.0318 | 0.0318 |
| Total coat | 2.932 | 2.932 |

### Example 7

### Testing

Core samples having dimensions of 1″×1.5″ (2.5 cm×3.8 cm) from the catalyst compositions of Examples 1, 2 and Comparative Examples 3 to 6 were aged at 950° C. for 12 hours using a cyclic rich lean gas composition. After aging, the catalysts of Examples 1 to 4 were evaluated using gasoline vehicle simulator (GVS), a cold start part (0 to 120 seconds) of European vehicle testing cycle (MVEG). Table 3 provides residual percentages of HC, CO, and NO, after the cold start phase. From the table, it can be concluded that a combination of Ce—Pr-based oxide and Ce—Zr-based oxide is essential to provide a light off advantage over a Ce—Zr-based oxide on a fully formulated catalyst (compare Examples 1, 2 and 3). A Ce—Pr based oxide alone does not provide an advantage over a Ce—Zr based oxide (compare Examples 3 and 4).

TABLE 3
Cold start data of core samples from
Examples 1, 2 and comparative examples 3, 4.

| | | Residual | Residual | Residual |
|---|---|---|---|---|
| | | HC | CO | NO |
| | Utilized Pd-support | by flow | by flow | by flow |
| Core sample | components | [%] | [%] | [%] |
| Example 1 | Ce—Pr and Ce—Zr | 29.6 | 42.3 | 9.4 |
| | based oxides | | | |
| Example 2 | Ce—Pr—La and | 28.1 | 40.7 | 10.6 |
| | Ce—Zr based oxides | | | |
| Comparative | Only Ce—Zr | 34.8 | 50.0 | 17.9 |
| Example 3 | based oxide | | | |
| Comparative | Only Ce—Pr | 37.8 | 57.2 | 27.2 |
| Example 4 | based oxide | | | |

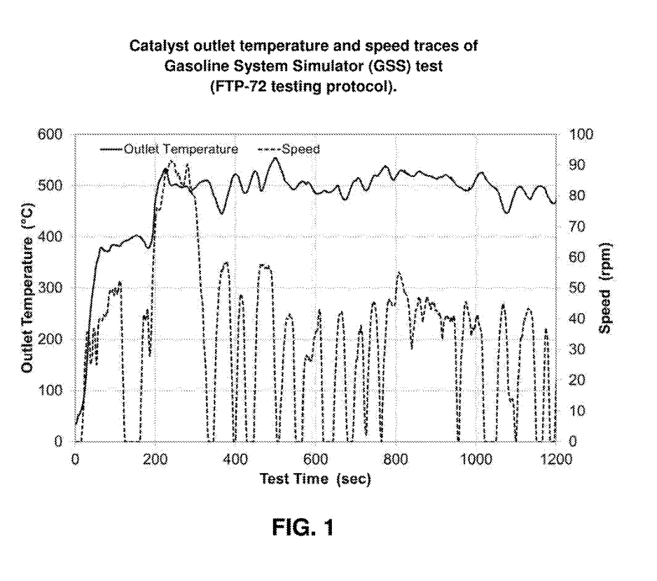

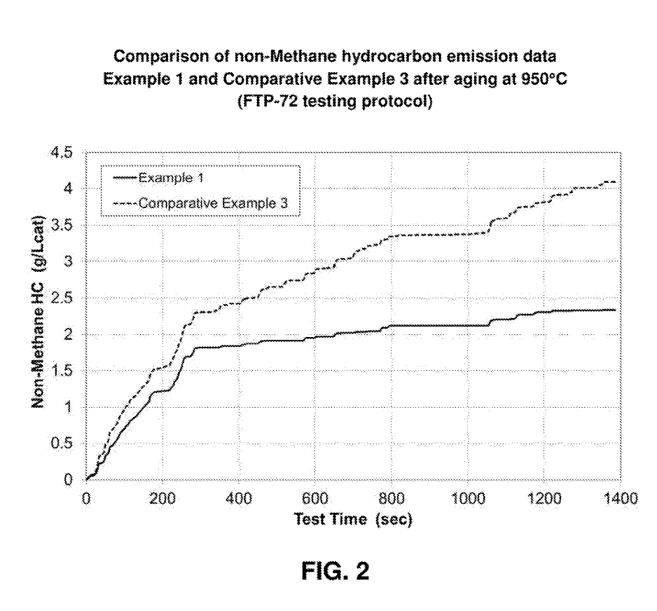

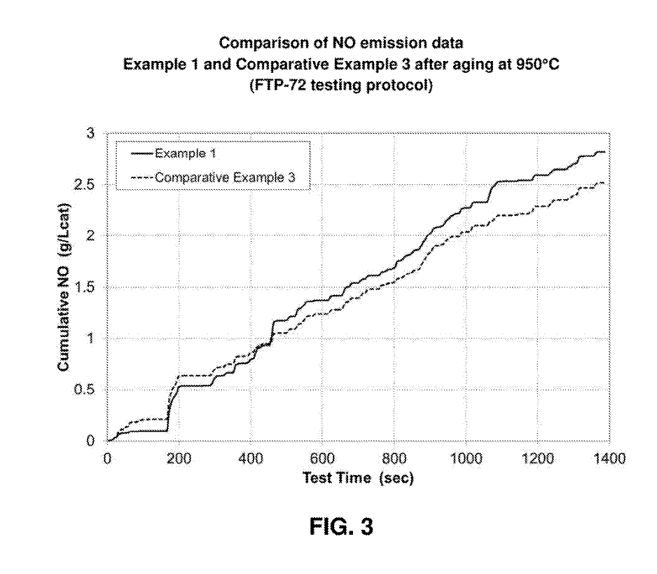

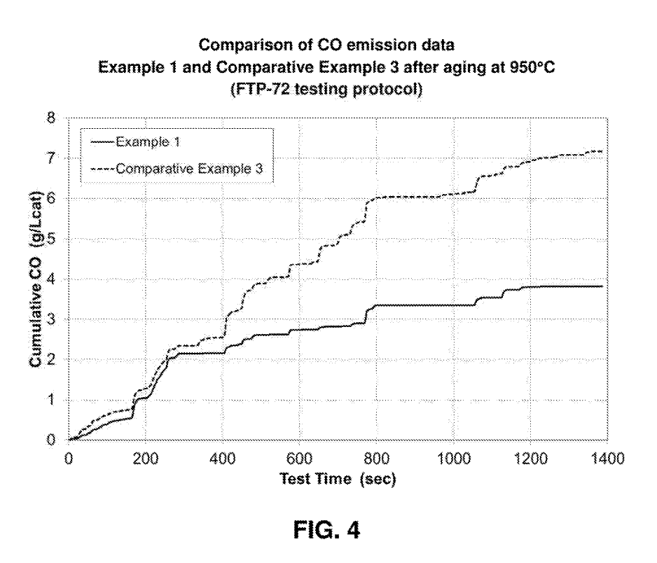

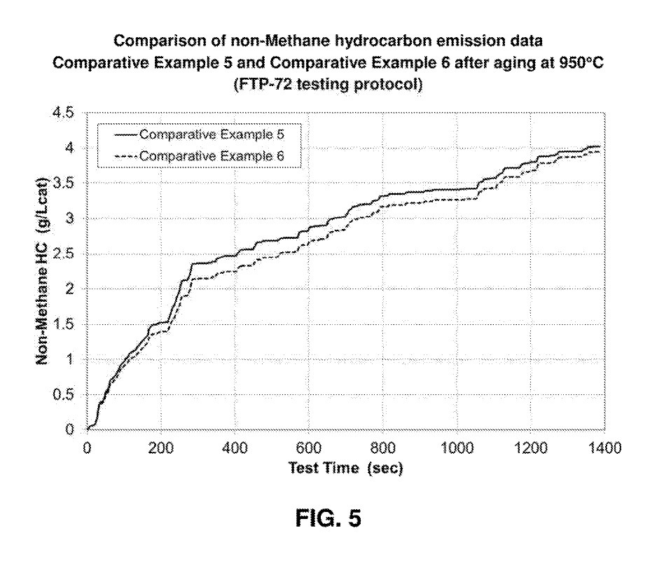

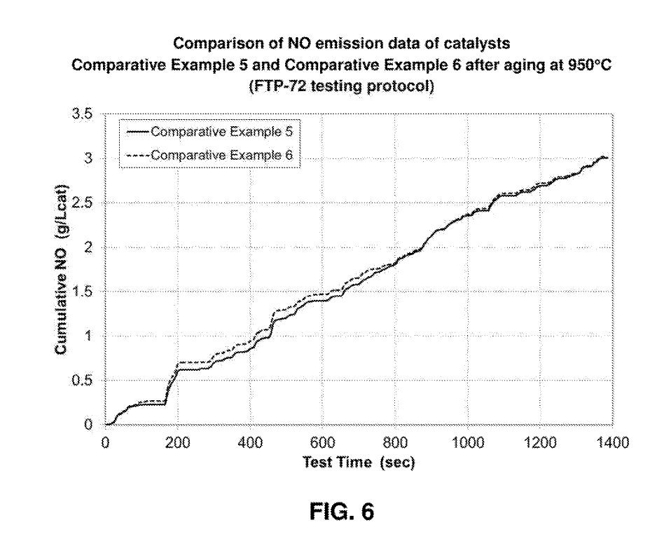

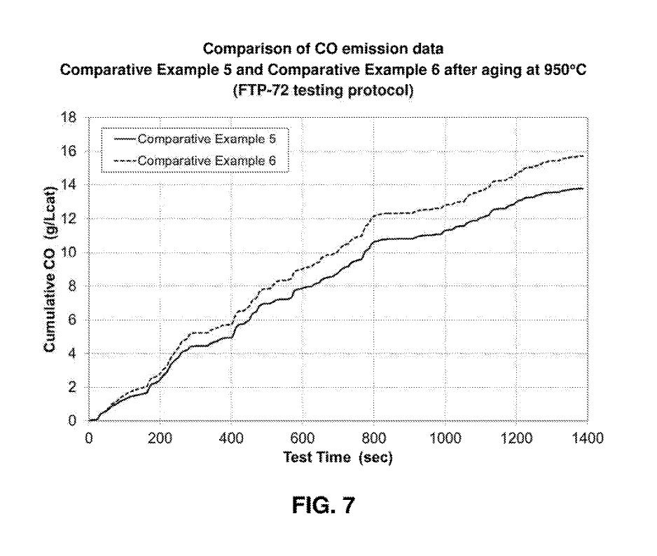

In addition, the aged catalysts of Examples 1, 3, 5 and 6 were evaluated using a gasoline system simulator (GSS) applying an FTP-72 testing protocol with temperature (° C.) and speed traces (rpm) shown in FIG. 1. Test results are shown in FIGS. 2-7. Table 4 provides a summary of the total non-methane hydrocarbons (NMHC), NO, and CO emissions. From the data, it can be concluded that a combination of Ce—Pr-based oxide and Ce—Zr-based oxide in the absence of alumina provides an advantage over only a Ce—Zr-based oxide with respect to [NMHC+NO] total emissions (compare Example 1 and comparative Example 3). Furthermore, it can be concluded that in the presence of alumina, a combination of Ce—Pr-based oxide and Ce—Zr-based oxide does not provide an advantage over a Ce—Zr based oxide with respect to [NMHC+NO] total emissions (compare comparative Example 5 and comparative Example 6).

TABLE 4
FTP-72 simulation data of core samples from Example 1 and comparative examples 3, 5, 6.

| | | | | Total | |
|---|---|---|---|---|---|
| | | Total NMHC | Total NO | [NMHC + NO] | Total CO |
| | Utilized Pd-support | emissions | emissions | emissions | emissions |
| Core sample | components | [g/l_{catalyst}] | [g/l_{catalyst}] | [g/l_{catalyst}] | [g/l_{catalyst}] |
| Example 1 | Ce—Pr and Ce—Zr | 2.33 | 2.82 | 5.15 | 3.82 |
| | based oxides | | | | |
| Comparative | Only Ce—Zr based | 4.09 | 2.52 | 6.61 | 7.17 |
| Example 3 | oxide | | | | |
| Comparative | Ce—Pr and Ce—Zr | 4.02 | 3.01 | 7.03 | 13.77 |
| Example 5 | based oxides and | | | | |
| | alumina | | | | |
| Comparative | Ce—Zr based oxide | 3.94 | 3.02 | 6.96 | 15.71 |
| Example 6 | and alumina | | | | |

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed is:

1. A catalyst composite for combustion engines comprising: a carrier and a first layer comprising a catalytic material on the carrier, the catalytic material comprising
a palladium component supported on both a ceria-praseodymia-based oxygen storage component and a ceria-zirconia-based oxygen storage component;
wherein the first layer is essentially free of alumina.

2. The composite of claim 1, wherein the catalytic material is effective to substantially simultaneously oxidize carbon monoxide and hydrocarbons and reduce nitrogen oxides present in a gaseous exhaust gas stream produced from the combustion engine.

3. The composite of claim 1, wherein the ceria-praseodymia-based oxygen storage component comprises, by weight on an oxide basis: about 30 to about 60% Ce; about 10 to about 50% Pr; 0 to about 30% rare earth elements selected from the group consisting of La, Y, and Nd; and less than or equal to about 10% Zr.

4. The composite of claim 1, wherein the ceria-zirconia-based oxygen storage component comprises, by weight on an oxide basis: about 10 to about 70% Ce; about 15 to about 90% Zr; and 0 to about 25% rare earth elements selected from the group consisting of La, Y, Pr, and Nd.

5. The composite of claim 1, wherein the first layer further comprises a non-alumina binder.

6. The composite of claim 5 wherein the non-alumina binder comprises submicron particles of a zirconium component, a titanium component, or a ceria component.

7. The composite of claim 1, wherein the ceria-praseodymia-based oxygen storage component and the ceria-zirconia-based oxygen storage component are present in a weight ratio of about 0.15:1 to about 1.5:1.

8. The composite of claim 1, wherein the ceria-praseodymia-based oxygen storage component and the ceria-zirconia-based oxygen storage component are present in a weight ratio of about 0.25:1 to about 1.5:1.

9. The composite of claim 1, wherein the ceria-praseodymia-based oxygen storage component and the ceria-zirconia-based oxygen storage component are present in a weight ratio of about 0.4:1 to about 0.7:1.

10. The composite of claim 1, wherein about 0.1 to about 50 wt. % of the palladium component is supported on the ceria-praseodymia-based oxygen storage component and about 50 to about 99.9 wt. % of the palladium component is supported on the ceria-zirconia-based oxygen storage component.

11. The composite of claim 1, wherein the ceria-praseodymia-based oxygen storage component and the ceria-zirconia-based oxygen storage component are present in a loading of about 0.5-3.5 g/in³.

12. The composite of claim 1, wherein the catalytic material further comprises a stabilizer material selected from the group consisting of barium, calcium, magnesium, strontium, and mixtures thereof.

13. The composite of claim 1, further comprising a second layer on the first layer, the second layer comprising a platinum group metal (PGM) component supported on a high surface area refractory metal oxide, an oxygen storage component, or combinations thereof.

14. The composite of claim 13, wherein the PGM component is supported on the high surface area refractory metal oxide and wherein the high surface area refractory metal oxide comprises a compound that is activated, stabilized, or both, and that is selected from the group consisting of alumina, alumina-zirconia, lanthana-alumina, lanthana-zirconia-alumina, baria-alumina, baria-lanthana-alumina, baria-lanthana-neodymia-alumina, and alumina-ceria.

15. The composite of claim 13, wherein the PGM component is supported on the oxygen storage component and wherein the oxygen storage component comprises a ceria-zirconia composite.

16. The composite of claim 13, wherein the PGM component comprises a palladium component, a rhodium component, or both.

17. The composite of claim 1, further comprising an undercoat that is on the carrier and below the first layer, wherein the undercoat is essentially free of any platinum group metals.

18. A system for treatment of an internal combustion engine exhaust stream including hydrocarbons, carbon monoxide, and nitrogen oxides, the emission treatment system comprising:
an exhaust conduit in fluid communication with the internal combustion engine via an exhaust manifold; and
the catalyst composite of claim 1.

19. A method for treating exhaust gases comprising contacting a gaseous stream comprising hydrocarbons, carbon monoxide, and nitrogen oxides with the catalyst composite of claim 1.

20. A method of making a catalyst composite comprising:
obtaining a carrier; and
coating the carrier with a first washcoat of catalytic material, wherein:
the first washcoat is essentially free of alumina and comprises a palladium component supported on both a ceria-praseodymia-based oxygen storage component and a ceria-zirconia-based oxygen storage component to give a coated carrier; and
drying and calcining the coated carrier to form a first layer on the catalyst composite.

21. The method of claim 20, further comprising:
coating a second washcoat on the first layer, wherein the second washcoat comprises a platinum group metal (PGM) component supported on a high surface area refractory metal oxide or on an oxygen storage component; and
drying and calcining the coated carrier to form a second layer on the catalyst composite.

22. The method of claim 20, further comprising adding a non-alumina binder to the first washcoat of catalytic material.
